(19) United States
(12) Patent Application Publication
(10) Pub. No.: US 2026/0017580 A1
(43) Pub. Date: Jan. 15, 2026

(54) SERVICE PROVIDING SYSTEM AND METHOD FOR SERVICE OPTIMIZATION OPERATION MANAGEMENT AND DECISION MAKING SUPPORT

(71) Applicant: Jae Won CHOI, Seoul (KR)

(72) Inventor: Jae Won CHOI, Seoul (KR)

(21) Appl. No.: 17/791,525

(22) PCT Filed: Jan. 25, 2021
(86) PCT No.: PCT/KR2021/000965

§ 371 Date: Jul. 7, 2022

(30) Foreign Application Priority Data
Feb. 5, 2022 (KR) 10-2020-0013835

(51) Int. Cl. G06Q 10/0631; H04L 41/16; H04L 41/22

(52) U.S. Cl. CPC G06Q 10/06312; G06Q 10/06313; H04L 41/16; H04L 41/22

(57) ABSTRACT

The present disclosure relates to a service providing system and method for supporting service optimization operation maintenance and decision-making. In more detail, the present disclosure relates to a service providing system and method for supporting service optimization operation maintenance and decision-making, the system and method being able to create prediction information about the usage and capacity of each of resources optimized through an optimization algorithm on the basis of current status-related status information about the usage and capacity of each of resources that are invested into a service when using an IT service (information communication service), being able to support decision-making for service optimization by providing a result of an optimal service driving environment considering an economic feasibility through comparison analysis using the status information and the prediction information, and being able to support automation of such service optimization.

### CROSS-REFERENCE TO RELATED APPLICATIONS

This application claims the priority of Korean Patent Applications No. 10-2020-0013835 filed on Feb. 5, 2020, in the Korean Intellectual Property Office, the disclosure of which is incorporated herein by reference.

### BACKGROUND OF THE INVENTION

### Field of the Invention

The present disclosure relates to a service providing system and method for supporting service optimization operation maintenance and decision-making. In more detail, the present disclosure relates to a service providing system and method for supporting service optimization operation maintenance and decision-making, the system and method being able to create prediction information about the usage and capacity of each resources of optimized through an optimization algorithm on the basis of current status-related status information about the usage and capacity of each of resources that are invested into a service when using an IT service (information communication service), being able to support decision-making for service optimization by providing a result of an optimal service driving environment considering an economic feasibility through comparison analysis using the status information and the prediction information, and being able to support automation of such service optimization.

### Description of the Related Art

Most companies construct internal/external Information Technology (IT) services for business and invest service resources, such as a data center (DC, IDC), an IT infrastructure (H/W, S/W, applications, etc.), a computer room (a computer environment with an IT infrastructure), and manpower, for such IT services.

Recently, importance of such IT services is continuously highlighted in various fields such as big data analysis or work efficiency optimization to secure competitiveness of companies. In particular, resources that are invested for IT services in ICT companies, the resources themselves are business operation subjects and factors that determine competitiveness of the companies, so it is required to support optimized maintenance of IT services and making-decision for optimizing the IT services.

Accordingly, since resources that are invested to implement IT services have high correlation, organic operation maintenance and optimization decision-making are required. At present, most companies distribute work to a business department (hereafter, business) and a technical department (hereafter, technique) in a broad meaning to perform businesses, and construct and operate separate operation management systems in accordance with work subdivided for the business and the technique, so organic cooperation between the business and the technique is difficult. Accordingly, such companies have considerable difficulty in optimizing operation maintenance and decision-making for IT services.

Accordingly, when IT services are optimized on the basis of a technology that puts first priority on disorder minimization and expansion such as duplicating and tripling to minimize disorders in relation to the IT services, relevant investment and costs are increased, which does not satisfy the references considered in business. Business can propose reduction objectives when it is required to reduce a cost (TCO), investment, cash flow, etc., but does not have insight and expertise about detailed implementation plans that can be implemented from such reduction objectives, so there is a problem that the references considered in business are not satisfied.

For example, technique just focuses on optimization of resources such as H/W and solutions without considering economic feasibility in the process of constructing infrastructures about big data analysis for improving the quality and operation efficiency of IT services. However, when the scale of big data increases, the infrastructure investment/operation management costs also increase, so a business that analyzes only economic feasibility according to profit-loss analysis has difficulty in receiving all of the resources required by technique. Accordingly, there is no model that gives support to be able to find an optimal contact point between business and technique, so there is a problem that it is failed to construct an optimized infrastructure.

Accordingly, big data for service optimization analysis are accumulated in real time in companies, but resources that use the big data are not optimized, so there is a problem that big data have to be managed to be periodically removed and only big data for analysis for coping with disorders irrespective of improving the quality and operation efficiency of IT services are secured.

As described above, in most companies, business is focused on the present status of assets invested into services and the business outcome and technique is focused on service quality management such as disorders, performance, and utilization, so one IT service is separated and operated into business and technique. Accordingly, Return On Investment (ROI), propriety of equipment candidates, reasons of selecting an enterprise, etc. are evaluated in consideration of a simple present operation status, such as an infrastructure and operation utilization, and demands at a specific point in time at most as considerations in decision-making of resource investment regardless of whether service optimization has been made and the degree or service optimization, whereby investment propriety is evaluated and determined. Therefore, there is a problem that the optimization quality required for IT services by companies of customers is not satisfied and the quality is only deteriorated.

Accordingly, it is required to develop a new model that gives support such that optimal investment decision-making is achieved to optimally manage IT services by combining the work fields of business and technique.

### SUMMARY OF THE INVENTION

In order to solve the problems described above, an objective of the present disclosure is to give support to easily perform decision-making such that optimal resources considering economic feasibility factors such as sale, subscribers, and the cost, which are considered in a business department, are invested into IT services for resources such as performance, capacity, and disorders for satisfying an expected quality of the IT services, which are considered in a technical department, in accordance with the operation status of the IT services, and is to give support to be able to optimize IT services through an optimal operation management model for satisfying an expected quality of the IT services by combining factors considered in the technical department and the business department.

Another objective of the present disclosure is to give support to perform decision-making that can maximize profit to resources that are invested to construct infrastructures relates to IT services.

A service providing system for supporting service optimization operation maintenance and decision-making according to an embodiment of the present disclosure may include: a terminal unit composed of a plurality of resources for providing an IT-related service and configured to create and transmit status information for each resource, which is used every time the services are driven; a data management unit configured to receive the status information from the terminal unit and process the status information into analysis data; a first integration calculation unit configured to calculate capacity and usage of each of investment resources required for driving the service on the basis of the analysis data received from the data management unit, and configured to create and store operation information including the capacity and usage of each of investment resources; an intellectual unit configured to create an optimization algorithm by teaching the interrelation between the capacity and usage of each investment resource to preset big data analysis or neural network model on the basis of the accumulated and stored operation information, and to create optimization information, in which at least one of capacity and usage of each investment resource, when driving a service by applying at least some of operation information for a present service operation status using the created optimization algorithm; and a second integration calculation unit configured to perform economic feasibility through a preset economic feasibility analysis algorithm by comparing the operation information created through the first integration calculation unit with the optimization information created through the intellectual unit in accordance with contract information for a predetermined contract of each of investment resources, and to create one or more different items of prediction information for a cost reduction specification according to a service driving environment, in which at least one of capacity and usage has been changed in the operation information for investment resources selected in accordance with the economic feasibility analysis, and variation of at least one of capacity and usage of the selected investment resources, thereby providing decision-making support for the service optimization on the basis of the prediction information.

As an example related to the present disclosure, the plurality of resources may include at least one of a sensor, a physical security device, an application, software, hardware, a line, a building, electricity, a machine, a server, a utility rack, including electricity, and manpower; and the operation information may include at least one of the kinds of resources, intensity of light according to an environment, a frame speed, image precision, magnitude of noise, storage capacity, capacity for processing users, the number of users, search performance, performance between a storage device and a cooperation device, a CPU speed, a packet process speed, a communication speed, a round trip time (RTT), a disc speed, cooling performance, a power consumption amount, the number of invested people, and work time.

As an example related to the present disclosure, the system may further include a user interface unit configured to display the prediction information through a display unit, to receive user input and inform a user of prediction information satisfying a preset condition in accordance with the user input, and to change setting of specific resources that are used for the service in accordance with user input or a preset operation condition.

As an example related to the present disclosure, the intellectual unit may receive setting change-related setting information about at least one of one or more resources, which are used for the service in accordance with user input through the user interface unit, and may create optimization information corresponding to the setting information by reflecting the setting information to the optimization algorithm; and the second integration calculation unit may create one or more items of prediction information for supporting decision-making for service optimization for a service operation environment corresponding to the setting information by applying optimization information corresponding to the operation information and the setting information to the economic feasibility algorithm.

As an example related to the present disclosure, the terminal unit may create and transmit status information of each resource that is used every time driving a service according to a specific function for each of a plurality of different functions set in advance in relation to an IT service.

As an example related to the present disclosure, the system may further include a contract unit configured to create and providing contract information including a contract of purchase and use of each resource and a labor contract, in which the first integration calculation unit may set contract information received from the contract unit into the second integration calculation unit.

As an example related to the present disclosure, when the terminal unit includes a plurality of terminals units and the plurality of terminal units are connected to each other, the data management unit may have connection information set in advance about a data cooperation relationship between the plurality of terminal units and may process status information provided from each of the plurality of terminal units in accordance with the connection information into the analysis data in accordance with the data cooperation relationship.

As an example related to the present disclosure, the second integration calculation unit may apply at least one of costs of resources, a rental, a rental feel, a labor cost, a depreciation expense, an electricity charge, and a fee according to the contract information to the economic feasibility analysis algorithm to create the prediction information.

As an example related to the present disclosure, the second integration calculation unit may calculate one or more service driving environments, in which the operation information has been changed, such that the difference from at least one of the usage and capacity of each investment resource, which is generated between the operation information and the optimization information, through the economic feasibility analysis algorithm, as candidate service driving environments; may calculate the final profit-loss by calculating and adding up profit-loss in accordance with each of investment resources, which need at least one of enlargement, a personnel increase, reduction, personnel reduction, performance optimization, service structure improvement, infrastructure optimization, utilization optimization, distribution, and bottleneck improvement according to the difference between the present service driving environment and the candidate service driving environments for each of the one or more candidate service driving environments; and may create the prediction information for each candidate service driving environment in which the final profit-loss satisfies a predetermined profit-loss condition.

A service providing method for supporting service optimization operation maintenance and decision-making according to an embodiment of the present disclosure may include: creating and transmitting status information for each resource, which is used every time the services are driven by means of a terminal unit composed of a plurality of resources for providing an IT-related service; receiving the status information from the terminal unit and processing the status information into analysis data by means of a data management unit; calculating capacity and usage of each of investment resources required for driving the service on the basis of the analysis data received from the data management unit, and creating and storing operation information including the capacity and usage of each of investment resources by means of a first integration calculation unit; creating an optimization algorithm by teaching the interrelation between the capacity and usage of each investment resource to preset big data analysis or neural network model on the basis of the accumulated and stored operation information, and creating optimization information, in which at least one of capacity and usage of each investment resource, when driving a service by applying at least some of operation information for a present service operation status using the created optimization algorithm by means of an intellectual unit; and performing economic feasibility through a preset economic feasibility analysis algorithm by comparing the operation information created through the first integration calculation unit with the optimization information created through the intellectual unit in accordance with contract information for a predetermined contract of each of investment resources, and creating, in accordance with variation, one or more different items of prediction information for a cost reduction specification according to a service driving environment, in which at least one of capacity and usage has been changed in the operation information for investment resources selected in accordance with the economic feasibility analysis, and variation of at least one of capacity and usage of the selected investment resources, by means of a second integration calculation unit, thereby providing decision-making support for the service optimization on the basis of the prediction information.

There is an effect that the present disclosure supports easily decision-making for optimization of a service driving environment that can maximally satisfy both a business department and a technical department by maximally reflecting a change of resources for service optimization, which is required by the technical department, and giving support such that the change of resources can satisfy profit-loss, which can be allowed by the business department, by providing a result for optimizing a plurality of resources required for providing a service on the basis of economic feasibility analysis by organically combining and analyzing operation points of the e technical department, such as performance, capacity, and disorders, and management points of the business department, such as sale, subscribers, and costs, when operating an IT service; and secure convenience for a user by automating the service optimization.

Further, there is an effect that the present can provide a service driving environment with high economical efficiency by giving support such that service optimization satisfying operation points of a business department, which operates IT services, is performed intensively in consideration of management points of a business department.

Further, there is an effect that the present disclosure can give support so that a user can easily compare an economic effect and variation of investment resources, which are expected when converting the present service driving environment of the terminal unit providing a service into one or more candidate service driving environments considering economic feasibility close to an optimal service driving environment, with the one or more candidate service driving environments; and accordingly, can give support such that best decision-making about an optimal service driving environment, which can satisfy all of a service operation management point of a technical department and an administration management points of a business department, is performed by giving support such that a user can easily select an optimal and best service driving environment satisfying user's reference of one or more candidate service driving environments.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a configuration diagram of a service providing for supporting service optimization operation system maintenance and decision-making according to an embodiment of the present disclosure;

FIG. 2 is a detailed configuration diagram of a terminal unit, a data management unit, and a contract unit constituting the service providing system for supporting service optimization operation maintenance and decision-making according to an embodiment of the present disclosure;

FIG. 3 is a detailed configuration diagram of a first integration calculation unit, a second integration calculation unit, and an intellectual unit of the service providing system for supporting service optimization operation maintenance and decision-making according to an embodiment of the present disclosure;

FIG. 4 is a configuration diagram of a cooperation unit and a user interface unit of the service providing system for supporting service optimization operation maintenance and decision-making according to an embodiment of the present disclosure;

FIG. 5 is an exemplary diagram showing a learning process of an optimization algorithm of the service providing system for supporting service optimization operation maintenance and decision-making according to an embodiment of the present disclosure;

FIGS. 6 to 9 are exemplary diagrams showing providing visualization information and report information created in accordance with optimization of a service driving environment of the service providing system for supporting service optimization operation maintenance and decision-making according to an embodiment of the present disclosure; and

FIG. 10 is a flowchart of a service providing method for supporting service optimization operation maintenance and decision-making according to an embodiment of the present disclosure.

### DETAILED DESCRIPTION OF THE INVENTION

Hereinafter, a detailed embodiment of the present disclosure will be described with reference to the drawings.

Before description, the present disclosure provides a model that supports easily decision-making for optimization of a service driving environment that can maximally satisfy both a business department and a technical department by maximally reflecting a change of resources for service optimization, which is required by the technical department, and giving support such that the change of resources can satisfy profit-loss, which can be allowed by the business department, by providing a result for optimizing a plurality of resources required for providing a service on the basis of economic feasibility analysis by organically combining and analyzing operation points of the technical department, such as performance, capacity, and disorders, and management points of the business department, such as sale, subscribers, and costs, when operating an Information Technology (IT) service (hereafter, a service).

Further, the present disclosure provides a model that can increase convenience for a user by gives support such that such service optimization is automated.

Further, the present disclosure provides a model that can provide a service driving environment with high economical efficiency by giving support such that service optimization satisfying points of a business department, which operates IT services, is performed intensively in consideration of management points of a business department.

That is, the present disclosure can automatically calculate and propose one or more contact points between requirements of a company department putting priority on different properties and of requirements a business department, can give support such that decision-making is easily performed on a best service driving environment for service optimization, which can satisfy both the business department and the technical department for service optimization on the basis of the contact points, and can secure automation of the service optimization.

A decision-making model is fundamentally a relationship of input and output and determines input when the input is larger than the output.

Accordingly, the present disclosure can derive expected service optimization effect, a target (To-be), and an execution plan (To-do) for the current situation (As-Is, including a new service), and comparison between the As-Is and the To-be may be measured and evaluated in various terms such as simple comparison (Output-Input), quality (performance, the number of taken subscribers, etc.), profit-loss, cost reduction, cash flow, and ROI.

Further, the present disclosure can evaluate an outcome level and degree of influence at a level such as an entire service aspect and individual equipment in relation to the evaluation range.

Further, the original business objective pursues sustainable business growth, so when comparison evaluation of input and output results in a business outcome, it results in profit (profit=revenue−cost).

The profit, revenue, and cost are each the product of capacity and a cost, and the capacity of investment resources (cost) is the maximum value of the investment resources (equipment, manpower, etc.), and maximum values of service components are related to each other.

Accordingly, since the capacity of each investment resource is closely connected with operation-related data of the investment resources, the present disclosure can provide an intelligence model that can derive an algorithm relates to capacity and usage using operation management big data, can implement automation of operation management and analysis for operation management and main decision-making of a service (business) on the basis of the algorithm, and can support quantitative decision-making for service optimization through big data analysis.

In this case, the IT service is a combination of several service functions, and investment resources (input) each have a maximum physical capacity value, but the minimum capacity of the maximum capacity of many investment resources are actually available values for a seamless service.

That is, when the capacity of a specific resource is insufficient, a situation in which the maximum values of other resources cannot be used may be generated, and wrong estimation of the capacity of a specific resource element may result in inefficiency of the entire service.

As an example of such resource capacity, individual physical equipment may be maximum process capacity and manpower may be a daily statutory working hours. A service maximum value is the minimum value of the maximum values of investment resources related to a service.

Detailed configuration of a service providing system for supporting service optimization operation maintenance and decision-making according to an embodiment of the present disclosure is described in detail on the basis of the above description.

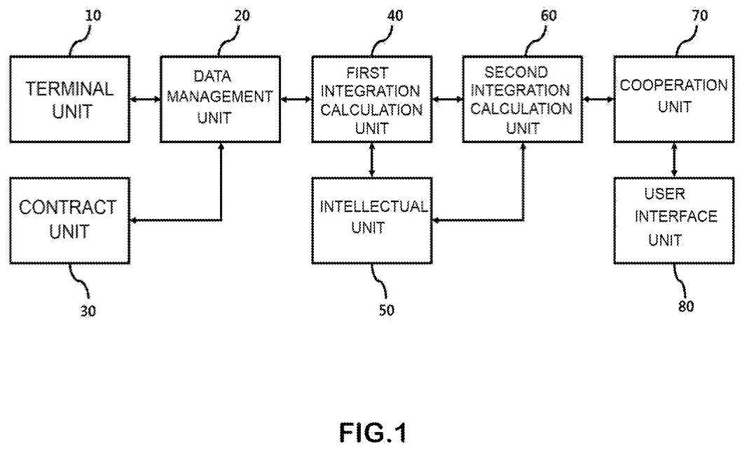

First, as shown in FIG. 1, a service providing system for supporting service optimization operation maintenance and decision-making according to an embodiment of the present disclosure may include a terminal unit 10, a contract unit 30, a data management unit 20, a first integration calculation unit 40, an intellectual unit 50, a second integration calculation unit 60, a cooperation unit 70, and a user interface unit 80 (or a self-operation management unit).

In this case, the terminal unit 10, the contract unit 30, the data management unit 20, the first integration calculation unit 40, the intellectual unit 50, the second integration calculation unit 60, the cooperation unit 70, and the user interface unit 80 constituting the service providing system for supporting service optimization operation maintenance and decision-making each may be a terminal (or a terminal device) or a server.

In this case, various terminals such as a personal computer (PC) and a smartphone may be applied as the terminal.

Further, at least one component of the terminal unit 10, the contract unit 30, the data management unit 20, the first integration calculation unit 40, the intellectual unit 50, the second integration calculation unit 60, the cooperation unit 70, and the user interface unit 80 constituting the service providing system for supporting service optimization operation maintenance and decision-making may be included in another component.

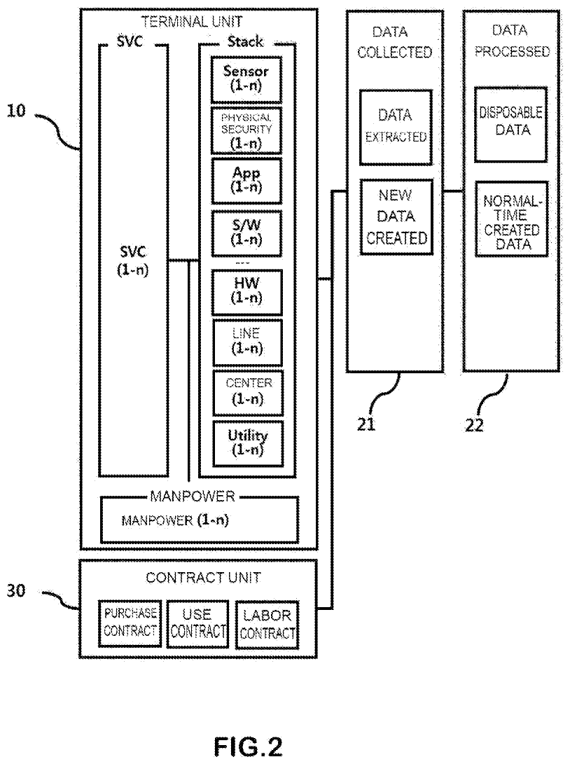

First, the detailed functions of the terminal unit 10, the data management unit 20, and the contract unit 30 are described with reference to FIG. 2.

As shown in the figure, the terminal unit 10 provides Information Technology (IT)-related services and the IT-related services, for example, may include various services such as a System Integration (SI) service related to a company, a Social Networking Service (SNS) for various users, a portal service, and a cloud service.

Further, the terminal unit 10 is composed of a plurality of resources for providing IT-related services and can create and transmit status information for each resource, which is used every time the services are driven, to the data management unit 20.

Further, the terminal unit 10 can create and transmit status information for each resource, which is used every time a service is driven, according to specific functions for each of a plurality of different functions set in advance in relation to the IT services.

In this case, the plurality of resources may include various resources such as a sensor, a physical security device, an application, software (S/W), hardware (H/W), a line, a building, electricity, a machine, a server, a rack, a utility, and manpower, and the status information may include a preset parameter for each property including various properties, which are used by the resources when the service is driven, or various properties related to specifications for supporting driving of the service of the resources.

The properties, for example, as for a server, may include various properties such as the capacity of each storage device of the server, the CPU sped of the server, a traffic capacity generated in the server when a service is driven, and the number of users of the server.

Further, the application can create log information into the status information.

Meanwhile, the data management unit 20 can receive the status information from the terminal unit 10 and can process the status information into analysis data.

To this end, the data management unit 20 may include a data collection unit 21 and a data process unit 22.

The data collection unit 21 can collect the status information, such as log and an operation status created by the terminal unit 10, from the terminal unit 10.

In this case, when additional data for the terminal unit 20 are required or data are not created in the terminal unit 10, new data may be defined and directly applied to the terminal unit 10.

In this case, the new data may be stored in the data collection unit 21 on the basis of input information according to user input that is provided from the user interface unit 80 to be described below.

Further, a gateway that creates the status information by collecting signals generated by specific resources, which do not have a function of creating the status information of a plurality of resources of the terminal unit 10, may be included in the terminal unit 10, and the terminal unit 10 can provide status information created for specific resources by the gateway to the data collection unit 21.

Further, the data process unit 220 can convert status information of the terminal unit 10 provided from the data collection unit 21 into analysis data in accordance with a preset standardization reference and can store the analysis data.

In this case, the data management unit 220 can add, remove, or redefine the analysis data in accordance with preset big data or artificial intelligence analysis model.

Meanwhile, in the configuration described above, a plurality of terminal units 10 may be provided and connected with the data management unit 20. When a plurality of terminal units 10 are connected to each other, the data management unit 20 may have connection information set in advance about a data cooperation relationship between the plurality of terminal units 10 and can process status information provided from each of the plurality of terminal units 10 in accordance with the connection information into the analysis data in accordance with the data cooperation relationship.

Meanwhile, the contract unit 30 can create and provide general contract information including a purchase contract for each resource, a use contract, and a labor contract.

In this case, the use contract, for example, as for resource lease, may include a fixed-fee contract type and a volume-based type in which a fee is charged in accordance with the usage.

Further, the contract information may include payment types such as advance payment or deferred payment, and as for advance payment according to a contract according to contract information, a contract may be set in the contract information in a way of subtracting a fee from the amount paid in advance in accordance with the usage.

A function of using the contract information of the contract unit 30 will be described in detail below.

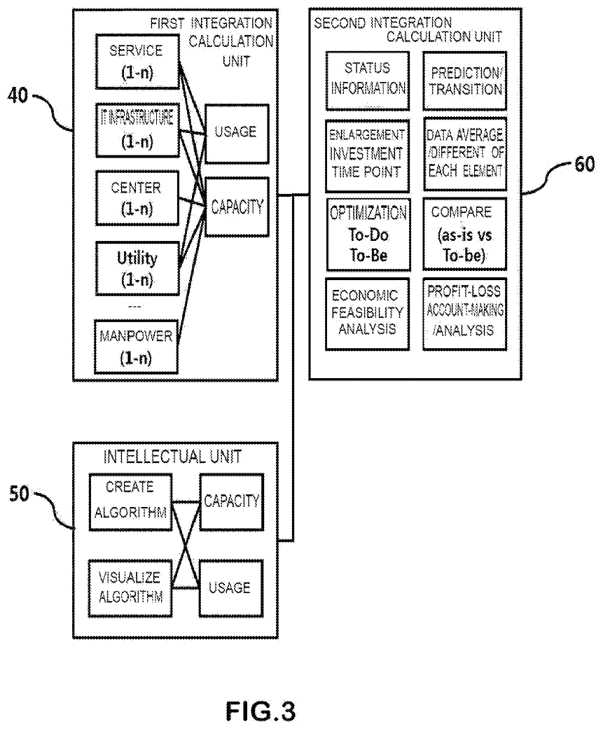

Meanwhile, the first integration calculation unit 40, the intellectual unit 50, and the second integration calculation unit 60 calculates an optimal operation status for optimizing the present operation status of a service and the operation status of the service, which is provide from the terminal unit 10, and supports a user to be able to select a best service optimization plan from one or more proposed prediction results by proposing one or more prediction results including a service optimization plan through economic feasibility analysis to optimize costs too that are generated when an investment resource is changed which is required in a process of optimizing the status of investment resources required for driving a service for changing the current operation status to be close to the optimal operation status, thereby being able to give support such that best decision-making that satisfies both a technical department and the business department is derived, which will be described in detail with reference to FIG. 3 on the basis of the configuration of FIG. 1.

As shown in the figures, the first integration calculation unit 40 can accumulate and store analysis data continuously received from the data management unit 20.

In this case, the first integration calculation unit 40 may include a DB for storing the analysis data.

Further, the first integration calculation unit 40 can calculate the capacity and usage of each of one or more investment resources required for driving the service of the plurality of resources on the basis of the analysis data received from the data management unit 20 and then accumulated and stored.

In this case, the first integration calculation unit 40 can create the operation information for each time at a predetermined cycle and can accumulate and store the operation information in the DB.

Further, the operation information may include various items of information such as the kinds of resources, the intensity of light according to an environment, a frame speed, image precision, the magnitude of noise, storage capacity, process capacity for users, the number of users, search performance, performance between a storage device and a cooperation device, a CPU speed, a packet process speed, a communication speed, a round trip time (RTT), a disc speed, cooling performance, a power consumption amount, the number of invested people, and work time.

In this case, the capacity of investment resources may mean capacity that investment resources required by the service have, and the usage of investment resource may mean use capacity of the investment resources that are used by the service when the service is driven.

For example, as for a login function of one or more different functions constituting the service, the first integration calculation unit 40 can calculate the capacity and usage of investment resource, which are used by the login function, in accordance with a preset measurement index (or measurement reference).

In detail, the first integration calculation unit 40 may use intangible investment resources such as a Web, a Web Application Server (WAS), general-purpose software (a DB, etc.), and an application in relation to a login function, and uses physical IT equipment such as hardware and a network device for driving the intangible investment resources as investment resources and uses a computer room space (a rack), IT, cooling electricity, etc. as investment resources for driving corresponding physical IT equipment. Accordingly, the first integration calculation unit 40 can calculate capacity and usage of each of investment resources, which are used by the login function, and can create operation information including the capacity and usage.

Further, the first integration calculation unit 40 may create the operation information by averaging analysis data for each investment resource accumulated and collected for a time included in one cycle at a predetermined cycle.

Meanwhile, the intellectual unit 50 can receive operation information created by the first integration calculation unit 40 from the first integration calculation unit 40 or can share the DB storing the operation information.

Accordingly, the intellectual unit 50 can create an optimized algorithm that has learned the interrelation between different investment resources on the basis of the operation information by teaching operation information accumulated and stored in the DB to an algorithm preset in the intellectual unit 50.

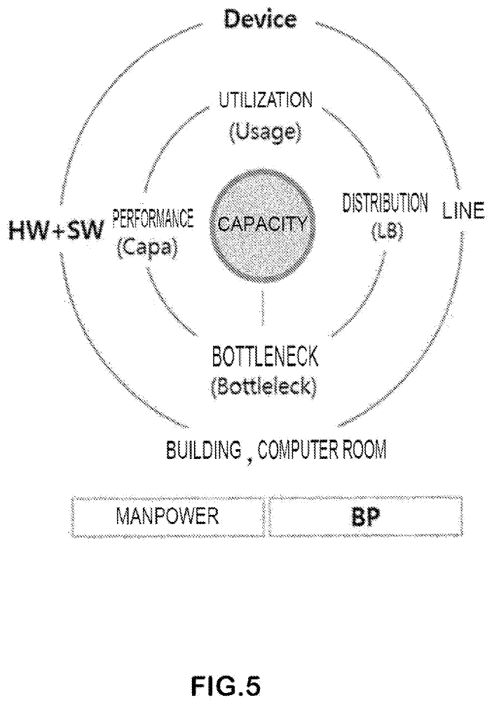

For example, as shown in FIG. 5, the intellectual unit 50 may teach the operation information to a preset algorithm for optimization for each of preset optimization target properties, such as usage, performance, distribution, and bottleneck phenomenon, in relation to the capacity included in the operation information such that interrelation satisfying optimization for each of the preset optimization target properties between different investment resources, such as hardware, software, a network device, a line, a building, and a computer room, is taught.

In this case, the algorithm preset in the intellectual unit 50 may be an artificial intelligence-based neural network model or big data analysis model, the neural network model (neural network) may be a deep learning algorithm composed of an input layer, one or more hidden layers, and an output layer, and various kinds of neural networks such as a Deep Neural Network (ENN), a Recurrent Neural Network (RNN), a Convolutional Neural Network (CNN), and a Support Vector Machine (SVM), may be applied to the neural network model.

Further, in accordance with the configuration described above, the intellectual unit 50 can create service optimization-related optimization information in which capacity or usage of each investment resource has been optimized in accordance with the interrelation when the service is driven by applying one or more of items of status information about the present service operation status to the optimization algorithm that has learned the interrelation.

That is, it is possible to create an optimization algorithm by teaching the interrelation between the capacity and usage of each investment resource to preset big data analysis of neural network model on the basis of the accumulated and stored operation information, and then predict optimal usage according to input capacity or optimal usage according to required usage on the basis the algorithm.

In this case, the investment resources have organic mutual relationship and a service is drive by using (consuming) the capacity of various investment resources (input), so one of logics of the algorithm set in the intellectual unit 50 is as the following Equation 1.

$${Input}_{n} capacity = \sum f ( sub - investment resource ‘ {sub\_input}_{n} ’ ) \qquad [ Equation 1 ]$$

$${Input}_{n} usage = \sum f ( sub - investment resource ‘ {sub\_input}_{n} ’ )$$

$${Input}_{n} ( capacity , usage ) = \sum f ( sub - investment resource ‘ {sub\_input}_{n} ’ )$$

where Sub input may be an investment resource corresponding to a lower level of preset specific input and n may mean the number of investment resources.

Further, the lower level means general investment resources (components) that are used by specific input.

Further, the lower investment resource may be composed of a core investment resource having direct relationship with a cost and an additional investment resource not having high relationship with the cost.

The core capacity is the capacity Of investment resources of which a capacity change directly results in a cost change and the main investment resources may include electricity (an electricity charge), an area (a rental), hardware (H/W)+software (S/W)+network (N/W) (rental, depreciation expense (investment)), manpower (labor cost, service expense), a line (communication facility fee), etc.

For example, when SVCₙ (capacity:electricity)=Σf(Sub Inputₙ:electricity), SVC (function, program) electrical capacity may be determined by physical equipment that is a lower investment resource (SVCₙcapacity=Σf(physical equipmentₙ), physical equipmentₙcapacity=Σf(Subphysical equipmentₙ)), and the physical equipment may be determined by lower investment resources such as software and an application (App) (physical equipmentₙ (capacity)=Σf(Sub input (softwareₙ, Appₙ, etc.)), and the service may be determined by a software function that is a lower investment resource (SVCₙcapacity=Σf(sub service functionₙ)).

Further, the plurality of items of operation information accumulated and stored in the DB each may include time information for a creation time and the intellectual unit 50 can create an optimization algorithm reflecting a time change by teaching the time information included in the operation information to the algorithm.

Accordingly, the intellectual unit 50 applies the recent operation information to one or more of the optimization algorithms, thereby being able to add pattern information about at least one optimal change time point of the capacity and usage of each investment resource and at least one optimization value variation transition of capacity and usage of different change time points to optimization information in which at least one of the capacity and usage of each investment resource has been optimized.

For example, the intellectual unit 50 can create and provide optimization information such that enlargement point of each investment resource can be found through big data analysis (optimal algorithm) about utilization and growth transition to supplied power capacity in relation to power consumption amount, and can gives support to be able to use corresponding optimization information for service optimization work related to investment, tuning, a fund plan, resource rearrangement, etc.

For example, as for a service function related to ‘service sign-up’, it is recorded (registered) in a DB through a web/WAS and each DB is implemented using DB server capacity (performance).

Since each DB server is driven using the center (rack) area and supplied power, SVC (function, program), S/W, H/W, a computer room, a data center, and a utility are sequentially connected to each other for a service and a ‘service sign-up’ process is performed, the final investment resource of the sing-up process is electricity.

Accordingly, the intellectual creates unit 50 information maximizing efficiency of each optimization investment resource such that the “service sign-up” process (function) is optimized, thereby being able to make the process (function) optimization outcome results in reduction of an electricity charge.

Meanwhile, the second integration calculation unit 60: performs economic feasibility analysis using an economic feasibility analysis algorithm by comparing operation information about the present service driving environment (present service driving status) of the terminal 10, which is created through the first integration calculation unit 40 in accordance with contract information about a preset contract of each investment resource, with optimization information about the optimal service driving environment (optimal service driving status) of the terminal 10 which is created through the intellectual unit 50; and creates one or more different items of prediction information about a cost reduction specification to the present service driving environment for existing service driving environment) according to a service driving environment, in which at least one of capacity and usage has been changed, in the operation information for each investment resource selected in accordance with the economic feasibility analysis and about at least one of capacity and usage of each of the selected investment resources, thereby being able to provide decision-making support for the service optimization on the basis of the prediction information.

In this case, the second integration calculation unit 60 can perform visualization for the interrelation between investment resources that are invested into (used for) a service on the basis of optimization information provided from the intellectual unit 50 in cooperation with the user interface unit 80, and can provide the visualization information created by performing such visualization to a display unit of the user interface unit 80.

Accordingly, the second integration calculation unit 60 can give support so that a user can easily visually understand the interrelation between the investment resources and can know service optimization elements by providing the visualization information.

The second integration calculation unit 60 may have a function of showing a result value using the function of the intellectual unit 50 and a new function connecting or combining the function of the intellectual unit 50 and an additional function. Further, the second integration calculation unit 60 can perform self functions such as profit and economic feasibility analysis using the quantity of the algorithm of the intellectual unit 50 and the data of a data unit.

Further, the first integration calculation unit 40 can set contract information received from the contract unit 40 in the second integration calculation unit 60.

Accordingly, the second integration calculation unit 60 can apply the costs of resources, a rental, a rental feel, a labor cost, a depreciation expense, an electricity charge, a fee, etc. according to the contract information to the economic feasibility analysis algorithm to create the prediction information.

In accordance with the configuration described above, the second integration calculation unit 60 applies operation information provided from the first integration calculation unit 40 and optimization information related to service optimization provided through the intellectual unit 50 to the economic feasibility analysis algorithm, thereby being able to create one or more different items of prediction information that include: environment information related to a candidate service driving environment (candidate service driving status), in which at least one of capacity and usage has been changed, of the operation information for each of investment resources selected to decrease the difference from the optimal service driving information according to the optimization information under a preset reference value on the basis of a present service driving environment according to the operation information through the economic feasibility analysis algorithm; profit-loss information about the final profit-loss generated when the operation information is converted into the environment information; and performing information related to variations (or variation value) of at least one of the capacity and usage of each of the selected investment resources.

That is, the prediction information may include the environment information, the profit-loss information, and the performing information.

Further, the second integration calculation unit 60 can provide a condition input function for economic feasibility analysis, etc., and can perform generally analysis on the second integration calculation unit 60 such as economic feasibility in accordance with preset conditions according to the condition input function or user setting conditions according to changes by a user.

For example, the second integration calculation unit 60: can calculate one or more different service driving environments, in which the operation information has been changed, such that the difference from at least one of the usage and capacity of each investment resource, which is generated between the operation information and the optimization information, through the economic feasibility analysis algorithm; can calculate the final profit-loss by calculating and adding up profit-loss in accordance with each of investment resources, which need at least one of enlargement, a personnel increase, reduction, personnel reduction, and load distribution according to the difference between the present service driving environment and the candidate service driving environments for each of the one or more candidate service driving environments; and can create the prediction information for each candidate service driving environment in which the final profit-loss satisfies a predetermined profit-loss condition.

Further, the second integration calculation unit 60 can create performing information about the variation of each investment resources, which need enlargement, a personnel increase, reduction, personnel reduction, and load distribution according to the difference between the present service driving environment and the candidate service driving information, and can put the performing information into the prediction information.

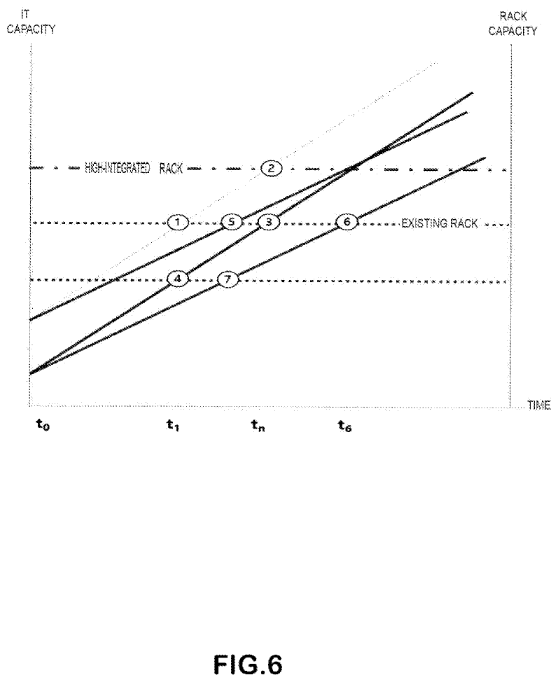

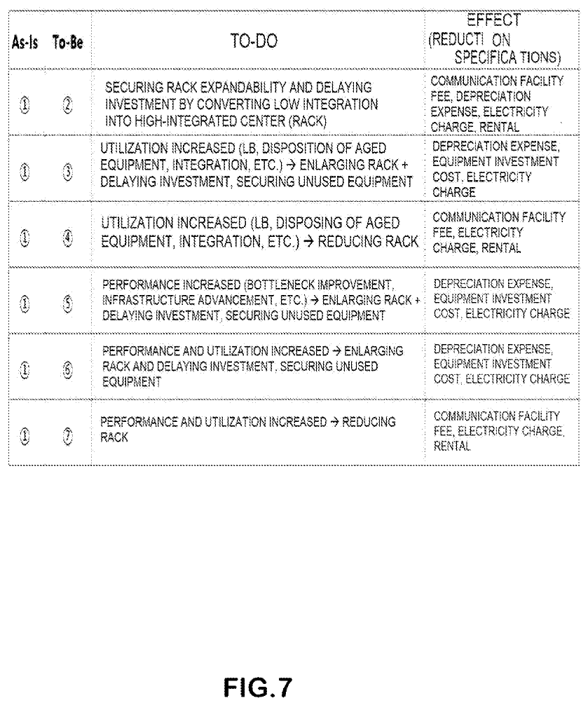

A detailed example thereof is described with reference to FIGS. 6 and 7. The second integration calculation unit 60 can calculate one or more different candidate service driving environments (\textcircled{2}˜\textcircled{7}, To-Be) satisfying that the difference from capacity and usage related to a rack configured in an optimal service driving environment according to the optimization information is under the reference value, on the basis of at least one of the capacity and usage related to the rack on the basis of the capacity (rack capacity) and usage (rack usage of a service and IT capacity in FIG. 6) of the rack that is an investment resource of the present service driving information according to the preset operation information (\textcircled{1}, As-Is).

In this case, it is apparent that the second integration calculation unit 60 may be set as various properties such as an analysis objective, and if necessary, physical equipment and service for the Y-axis in the graph of FIG. 6 to be used in various ways.

In this case, the second integration calculation unit 60 can create the performing information (To-D) about the variation of each of investment resources in which at least one of capacity and usage has been changed in comparison to the present service driving environment for each of the candidate service driving environments.

Further, the second integration calculation unit 60 can calculate final profit-loss by calculating and adding up profit-loss according to the contract information for each investment resource that needs at least one of a plurality of optimization object elements such as enlargement, a personnel increase, reduction, personnel reduction, performance optimization, service structure improvement, infrastructure optimization, utilization, distribution (e.g., load distribution), and bottleneck improvement according to the difference between the present service driving environment and the candidate service driving environment.

In this case, the second integration calculation unit 60 can create and provide the profit-loss information about the cost reduction specification on the basis of profit-loss according to the contract information when at least one of the rack capacity and usage is changed from the present service driving environment to the candidate service driving environment.

Accordingly, as shown in FIG. 7, the second integration calculation unit 60 selects one or more candidate service driving environments, in which the final profit-loss according to the profit-loss information satisfies a preset profit-loss condition, as final service driving environments from one or more candidate service driving environments satisfying that the difference is under the reference value, and creates prediction information including the environment information, profit-loss information (reduction specification in FIG. 7), and performing information (To-Do in FIG. 7) for each of the selected one or more final service driving environments (\textcircled{2}˜\textcircled{7}, To-Be), thereby providing result information including one or more items of prediction information corresponding to the selected one or more final service driving environments (\textcircled{2}˜\textcircled{7}, To-Be) to the user interface unit 80.

Accordingly, the second integration calculation unit 60 may enable visualization information shown in FIGS. 6 and 7 to be created on the basis of the result information in the user interface unit 80 and may enable the one or more prediction information to be visualized and displayed through the display unit of the user interface unit 80.

In this case, the second integration calculation unit 60 can receive optimization information added with pattern information about at least one optimization value variation transition of the capacity and usage of each investment resource at at least one optimal change time point and each of different change time points of the capacity and usage of the investment resources from the intellectual unit 50, can create one or more service driving environments, in which the different changes over time, by applying the optimization information including the pattern information and the operation information to the economic feasibility analysis algorithm, and can select a service driving environment having a different that is under the reference value of the differences for times as the candidate service driving environment from one or ore service driving environments.

Accordingly, the second integration calculation unit 60 can set the time, at which the difference becomes under a preset reference value, for a specific investment resource as the optimal change time point of the specific investment resource for the specific investment resources in the candidate service driving environment reflecting the difference over time, and can put the optimal change time point of each investment resource corresponding to the candidate service driving environment selected as the final service driving environment into the prediction information.

Meanwhile, the second integration calculation unit 60 can apply contract information in the following way when applying contract information to an economic feasibility analysis algorithm.

For example, purchase contract objects are usually tangible and intangible assets, which are items that are converted into depreciation expenses in cost conversion.

Further, some purchase contract (service contract) such as development may be treated as disposable costs or converted in the manufacturing costs, which may be determined in accordance with the characteristic of the project and internal management accounting references.

Further, a cost item may be determined in a use contract in accordance with the kinds of services.

For example, a line may be determined as a cost item by a communication facility fee, a building, a server, a cloud, etc. may be determined as cost items by a rental, electricity may be determined as a cost item by an electricity charge, and gas, water, etc. may be determined as a cost item by electricity and heating expenses, etc.

Accordingly, the cost items are determined in accordance with the kind of the terminal unit 10, a contract type, and an accounting reference, and may be temporal data that are determined at the time point of contract.

Further, the second integration calculation unit 60 can use an economic feasibility analysis algorithm employing the following Equation 2 and Equation 3 to create the prediction information.

$$Revenue = \sum f ( {Q}_{n} , {P}_{n} ) \qquad [ Equation 2 ]$$

$${Q}_{n} ( capacity ) = \sum f ( sub - investment resource : {Sub\_Input}_{n} )$$

$${Q}_{n} : f ( {Session}_{n} , {Connection}_{n} )$$

$${P}_{n} = f ( {cost}_{n} per Q of each product / service )$$

where Q may be defined by a customer, a product, and a service scale and may be a measurable index that is operated in real time. Further, n may be a quantity.

Further, it may be set that customer scale=quantity of products+Connection, Session (Billed): availability of finance.

$$Cost = \sum f ( {q}_{n} n , {p}_{n} ) \qquad [ Equation 3 ]$$

$${q}_{n} n : {Input}_{n} ( capacity ) = \sum f ( sub - investment resource : {Sub\_Input}_{n} )$$

$${p}_{n} = f ( {cost}_{n} of invested q , {cost}_{n} of q to be invested )$$

Further, as properties that are applied to the economic feasibility analysis algorithm, there are a customer maintenance cost and a customer attraction cost, in which the customer attraction cost (CAC) is a value obtained by dividing the costs of investment resources by the current customer scale and the customer attraction cost (CRC) may include investment (or investment resources) and costs that are put in to attract new customers (q).

Accordingly, the second integration calculation unit 60 can calculate one or more items of prediction information by applying operation information, which includes parameters of properties related to the customer maintenance cost and the customer attraction cost, to the economic feasibility analysis algorithm.

Further, the second integration calculation unit 60 can perform main business output analysis through service optimization using a economic feasibility analysis algorithm, can create, as an economic feasibility outcome of comparison of operation information (As-Is) and optimization information (To-Be) and service optimization (capacity, performance, etc.), outcome analysis information, such as TCO, P/L, BEP, an investment time point, a growth rate, cash flow, ROI/NPV, company value evaluation, MAU, CAC, CRC, LTV, and stickness, to corresponding to one or more items of prediction information, respectively, through the economic feasibility analysis algorithm.

Further, some conditions such as a WACC (financing interest) may be automatically set in accordance with a self reference (in cooperation with a loan interest of common commercial banks), and the second integration calculation unit 60 can provide a menu in cooperation with the user interface unit 80 such that a user can change conditions.

Meanwhile, when a plurality of terminal units 10 is provided, the second integration calculation unit 60 can detect a bottleneck of a specific part through interrelation analysis between the terminals 10.

In this case, the economic feasibility analysis algorithm can analyze a meaningful difference between the average and the difference of parts connected between services through statistics and AI.

An optimization process of the terminal units 20 can be supported to be performed on the basis of the analysis information calculated through the analysis of the second integration calculation unit 60.

For example, when the memory of a specific terminal 10 constituting a service is insufficient, enlargement of the memory may be performed, and when the load of a specific terminal 10 is high, distribution work may be performed. Further, when the process speed is higher than the average or smaller than a critical value, performance improvement work may be performed.

Meanwhile, when applying and comparing operation information and optimization information to the economic feasibility analysis algorithm, the second integration calculation unit 60 can perform quality comparison including differences of performance, capacity, and utilization between the operation information and the optimization information through the economic feasibility analysis algorithm, and can analyze a difference for each of items included in the quality using the cost information of the contract unit 30.

Further, the second integration calculation unit 60 can create result information including one or more items of prediction information calculated by applying the operation information and the optimization information to the economic feasibility analysis algorithm, and can provide the result information to the user interface unit 80.

In this case, the second integration calculation unit 60 may put and provide the output analysis information into the result information.

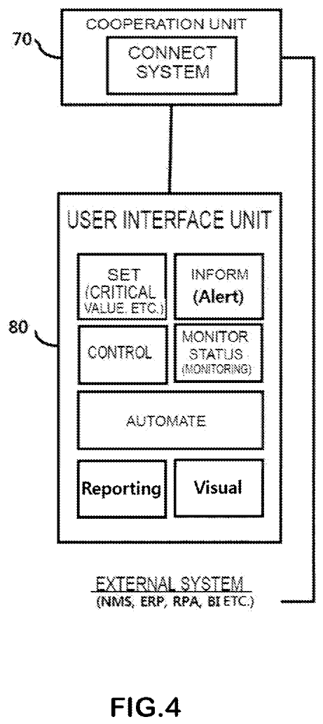

Meanwhile, the second integration calculation unit 60 can gives support such that result information, which includes one or more items of prediction information created as described above, is visualized and displayed through the display unit of the user interface unit 80 by providing the result information to the user interface unit 80. The user interface unit 80 displays the result information and selects and provides prediction information satisfying a predetermined condition on the basis of the result information, or inputs virtual operation information related to a virtual service driving environment, in which investment resources selected by a user have been changed in accordance with user input, of operation information in accordance with a change of customers entering a service or economic feasibility, into the intellectual unit 50 such that optimization information optimized for the virtual service driving environment is calculated, and can gives support such that prediction information about an optimal (best) candidate service driving environment considering economic feasibility is calculated by the second integration calculation unit 60 on the basis of the virtual operation information, which will be described in detail with reference to the configuration of FIG. 4 on the basis of the configuration of FIG. 1.

As shown in the figures, the cooperation unit 70 can support communication and interface between the second integration calculation unit 60 and the user interface unit 80.

Further, the cooperation unit 70 may be configured for cooperation of service development, such as operation management, and another system using the function and data of the second integration calculation unit 60, and the cooperation method may support SDK, Rest API, DB cooperation, etc.

Meanwhile, the user interface 80 may have one or more items of prediction information included in the result information or may display the prediction information through a display unit connected with the user interface unit 80.

In this case, the display unit may be an output device such as a display.

Further, the user interface unit 80 can receive user prediction information input and inform the user of satisfying a condition set in accordance with the user input through the display unit.

For example, as shown in FIG. 6, the user interface unit 80 can extract items of prediction information, which corresponds to one or more different candidate service driving environments calculated by the second integration calculation unit 60 (candidate service driving environments selected as final service driving environments), respectively, from the result information by applying the operation information and optimization information to the economic feasibility analysis algorithm, and can create and display visualization information (\textcircled{2}˜\textcircled{7}) showing the items of prediction information included in the result information in graph through the display unit.

In this case, the user interface unit 80 can receive operation information created by the first integration calculation unit 40 from the second integration calculation unit 60, and can show the operation information (\textcircled{1}) together with the prediction information in graph and then put and display the information into the visualization information through the display unit.

Accordingly, the user interface unit 80 can gives support so that a user can visually easily know the difference between the prediction information and the operation information, and can give support such that decision-making that can satisfy the intention of both a technical department and a business department is performed by selecting a candidate service driving environment with the smallest difference or enabling a user to select a service driving environment with high service efficiency from candidate service driving environments close to an optimal service driving environment.

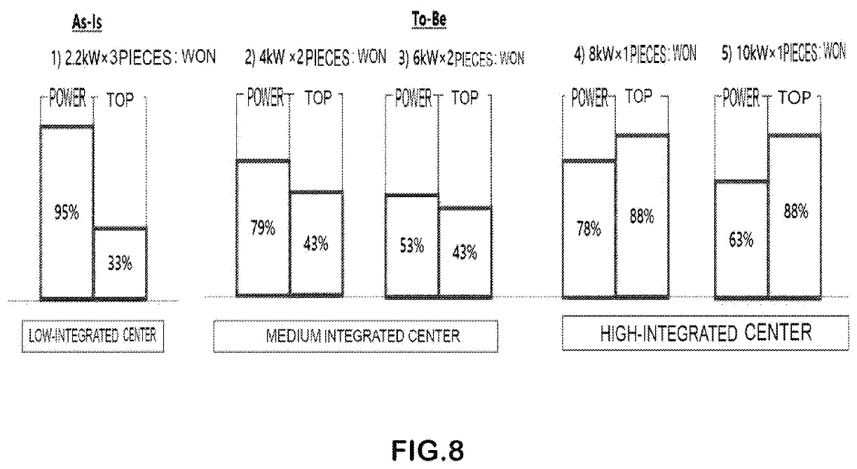

In this case, as shown in FIG. 8, the user interface 80 may create and provide visualization information showing the result information in a chart.

Further, as shown in FIG. 7, the user interface unit 80 can create and display report information, which is created on the basis of profit-loss information included in prediction information for final profit-loss generated when converting operation information (As-Is, \textcircled{1}) for the present service driving environment into the environment information for a candidate driving environment, in which the difference between the optimal service driving environment and the present service driving environment is under a preset reference value, and on the basis of performing information (To-Do) included in prediction information for variations (or variation value) for at least one of capacity and usage of each of investment resources selected to convert the present service driving environment into the candidate service driving environment, through the display unit for each of items of prediction information (To-Be, \textcircled{2}˜\textcircled{7}) included in the result information.

For example, the user interface unit 80 can secure rack expandability and create and display report information about variation of investment resources that delay investment through the display unit by converting a low-integrated rack, which is the present service driving environment, into a high-integrated rack in relation to a rack, which is an investment resource in which at least one of capacity and usage has been changed, on the basis of performing information according to conversion of the present service driving environment (\textcircled{1}) into a candidate service driving environment included in specific prediction information (\textcircled{2}) in accordance with the specific prediction information included result information.

Further, the user interface unit 80 can put and provide profit-loss information, which is included in the specific prediction information, into the report information, and can provide a user with profit-loss information about cost reduction specifications (a communication facility fee, a depreciation expense, an electricity charge, a rental, etc.) expected when converting the present service driving environment into a candidate service driving environment in accordance with variation set in the specific prediction information.

Further, the user interface unit 80 can create and provide report information about variation related to reduction of a rack, which is an investment resource changed to increase performance and utilization of a service in the present service driving environment, to the user through the display unit on the basis of performing information according to conversion of the present service driving environment (\textcircled{1}) into a candidate service driving environment (\textcircled{7}) included in another prediction information in accordance with the another prediction information included in result information.

Further, the user interface unit 80 can put and provide profit-loss information, which is included in the another prediction information, into the report information, and can provide a user with profit-loss information about cost reduction specifications (a communication facility fee, an electricity charge, a rental, etc.) expected when converting the present service driving environment into a candidate service driving environment in accordance with variation set in the another prediction information.

Further, the user interface unit 80 can provide information about a result by the second integration calculation unit 60 or an analysis result according to To-Do other than profit-loss information.

As described above, the user interface 80 can create and provide visualization information and report information for each of one or more items of prediction information included in result information; can give support so that a user can easily compare an economic effect and variation of investment resources, which are expected when converting the present service driving environment of the terminal unit 10 providing a service through the visualization information and the report information into one or more candidate service driving environments considering economic feasibility close to an optimal service driving environment, with the one or more candidate service driving environments; and accordingly, can give support such that decision-making about a service driving environment having an optimal (best) service efficiency, which can satisfy all of a service operation management point of a technical department and an administration management points of a business department, is performed by giving support such that a user can easily select optimal (best) service driving environment satisfying user's reference of one or more candidate service driving environments.

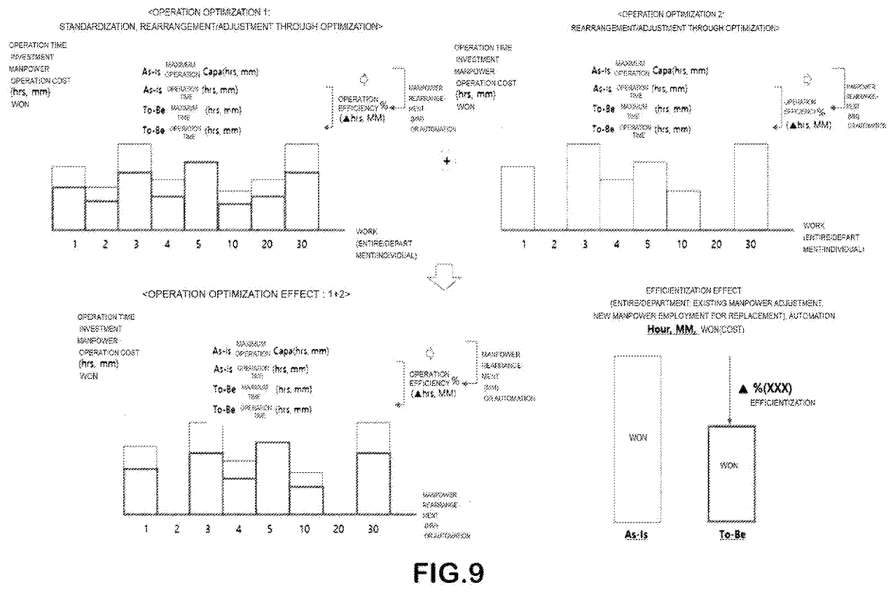

Meanwhile, as shown in FIG. 9, the user interface 80 may show outcome analysis information, which is included in the result information and created by the second integration calculation unit 60 for each of one or more items of prediction information, in a chart type, and put and provide the outcome analysis information into the visualization information.

Accordingly, it is possible to give support such that subject performance and outcome according to a candidate service driving environment (To-Be) for service optimization and performing information (To-Do) that is an execution plan for the candidate service driving environment are managed and evaluated by a user.

In this case, the outcome analysis information calculated by the second integration calculation unit 60 may be provided automatically on the basis of the following analysis on the basis of a fundamental algorithm through big data analysis.

An expected effect (Before To-Do) and outcome (After To-Do) logic of a service optimization activity is as follows.

[To-do (1) marketing+cost 2) planning+investment+3) operation management improvement→Output/Input cost (quality improvement, indirect business effect, direct business effect)]

In this case, the second integration analysis unit can calculate the outcome analysis information in correspondence to the prediction information through a fundamental algorithm that has learned in advance the interrelation between the prediction information and the outcome analysis information.

For example,
To-Do→utilization improvement
To-do→in-equipment capacity security=indirect effect:investment cost reduction, removal/reduction of cash flow increase factor, resource rearrangement between services
To-Do→reserve equipment security=indirect effect:individual service cost reduction
To-Do→reserve equipment security=direct effect and new service investment: cashflow reduction

An example of corresponding application is as follows

(1) Main To-do activities: performance tuning, load distribution, utilization, bottleneck, service structure improvement, service advancement (center, H/W, S/W, App, etc.), production release, promotion, etc.

(2) Expected effect (To-Do) and outcome (After To-Do)
Sale: subscriber increase, sale increase, etc.
Cost/profit-loss: removal of cash, investment scale generation factors or increase/decrease scale reduction through security of reserve capacity although there is no direct/indirect cost increase/decrease, entire cost increase/decrease
Investment: investment time point changed and investment scale calculated
Cashflow: Cash flow increased/decreased (time point, scale, etc.)
TCO: entire, individual service indirect/direction cost reduction
Capacity: investment resource scale calculated
Specification: optimal specification calculated
Performance: demand process capacity

Meanwhile, the user interface unit 80 can change setting of specific resources that are used for the service in accordance with user input or a preset action condition.

In this case, the intellectual unit 50 can receive setting change-related setting information about at least one of one or more resources, which are used for the service in accordance with user input through the user interface unit 80, from the user interface unit 80, and can create optimization information corresponding to the setting information by reflecting the setting information to the economic feasibility analysis algorithm.

Accordingly, the second integration calculation unit 60 can create one or more items of prediction information for decision-making for service optimization, as supporting described above, for a service operation environment corresponding to the setting information applying optimization information corresponding to the operation information received from the first integration calculation unit 40 and the setting information received from the intellectual unit 50 to the economic feasibility algorithm, and can provide result information including one or more items of prediction information corresponding to the setting information to the user interface unit 80.

Further, the user interface unit 80 can create and provide report information and visualization information, as described above, on the basis of the result information.

That is, the user interface unit 80 can give support to be able to set a virtual service driving environment by changing at least one of capacity and usage for each of one or more investment resources selected by a user from one or more investment resources according to the operation information in accordance with user input in the current service driving environment according to the operation information.

Further, the intellectual unit 50 can create and provide optimization information for an optimal service driving environment optimizing the virtual service driving environment to the second integration calculation unit 60 by applying setting information about the virtual service driving environment to the optimization algorithm, and the second integration calculation unit 60 can create and provide result information including the one or more items of prediction information through the user interface unit 80 by applying optimization information provided from the intellectual unit 50 optimizing a service driving environment virtually configured by a user together with the operation information to the economic feasibility analysis algorithm.

According to this configuration, the present disclosure supports a user to be able to try to configure virtual service driving environments for the present service driving environment in various ways to correspond to a service objective intended by the user, and proposes an optimal service driving environment for a changed virtual service driving environment to the user, thereby being able to support the user to be able to dry simulate various service driving environments corresponding to the service objective, and accordingly, to be able to construct an optimal service driving environment.

Meanwhile, the user interface unit 80 may monitor the operation status of the terminal unit 10 and may control the function of the terminal unit 10 to manually or automatically perform specific operations (/Off, Hold, Acceleration, etc.) of the terminal unit 10.

Accordingly, the status information that is provided from the user terminal 10 to the data collection unit 21 can be changed, and the second integration calculation unit 60 can provide result information about an optimal service driving environment considering economic feasibility in accordance with the operation status of the terminal unit 10.

Further, the user interface unit 80 automatically or manually performs relevant functions in accordance with specific conditions by automating operation management work, whereby specific functions verified in accordance with a service optimization model can automatically perform work.

That is, the user interface unit 80 can manually select any one of one or more items of prediction information included in the result information in accordance with user input or can automatically select the any one by comparing economic feasibility and outcome analysis of one or more items of prediction information, and can automatically change at least one of capacity and usage of each of investment resources that can be changed in the present service driving environment of the terminal unit 10 on the basis of performing information and operation information included in manually or automatically selected prediction information.

For example, the user interface unit 80 can automate specific work, such as performing automatic solution upgrade based on a scheduler on a solution patch on the basis of automatically or manually selected prediction information, on the basis of a script, a program, or an autonomous operation algorithm.

That is, the user interface unit 80 can automatically perform To-Do and To-Be on the basis of To-be setting and a To-do learning result (including outcome analysis) in accordance with a service optimization model according to selected prediction information.

As described above, the present disclosure can give support to easily perform decision-making such that optimal resources considering economic feasibility factors such as sale, subscribers, and the cost, which are considered in a business department, are invested into IT services for resources such as performance, capacity, and disorders for satisfying an expected quality of the IT services, which are considered in a technical department, in accordance with the operation status and the design direction of the IT services, and is to give support to be able to optimize IT services through an optimal operation management model for satisfying an expected quality of the IT services by combining factors department and the business considered in the technical department.

Further, the present disclosure can give support to perform decision-making that can maximize a profit to resources that are invested to construct infrastructures relates to IT services.

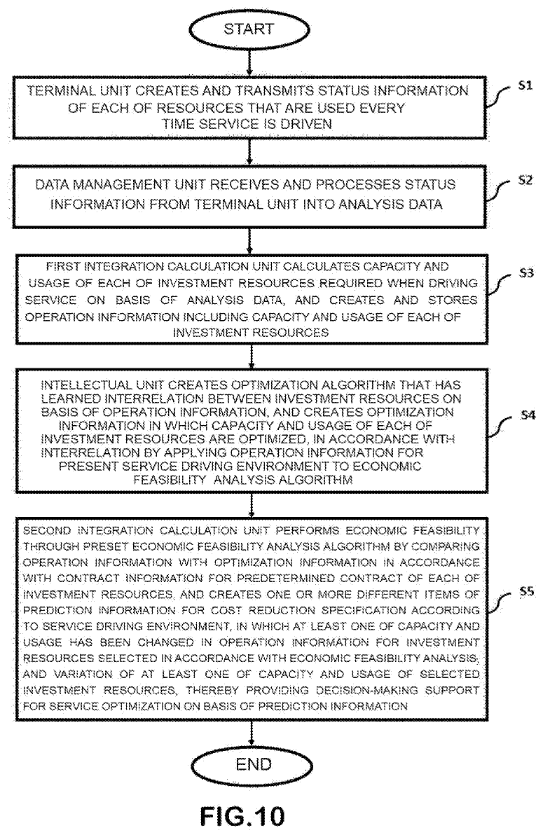

FIG. 10 is a flowchart of a service providing method for supporting service optimization operation maintenance and decision-making.

As shown in the figure, the terminal unit 10 composed of a plurality of resources for providing IT-related services can create and transmit status information of each of resources that are used every time a service is driven (S1).

In this case, the terminal unit 10 can have a pre-registered value or an average value in designing, and can create and transmit status information of each of resources on the basis of the pre-registered value or the average value.

Further, the data management unit 20 can receive and process the status information from the terminal unit 10 into analysis data (S2).

Further, the first integration calculation unit 40 can calculate capacity and usage of each of investment resources required when driving the service on the basis of analysis data received from the data management unit 20, and can create and store operation information including the capacity and usage of each of investment resources (S3).

Further, the intellectual unit 50 can create an optimization algorithm that has learned interrelation between the investment resources on the basis of the operation information, and can create optimization information in which the capacity and usage of each of investment resources are optimized, in accordance with the interrelation by applying the operation information for the present service driving environment to the economic feasibility analysis algorithm (S4).

Further, the second integration calculation unit 60 performs economic feasibility through a preset economic feasibility analysis algorithm by comparing the operation information created through the first integration calculation unit 40 with the optimization information created through the intellectual unit 50 in accordance with contract information for a predetermined contract of each of investment resources, and creates one or more different items of prediction information for a cost reduction specification according to a service driving environment, in which at least one of capacity and usage has been changed in the operation information for investment resources selected in accordance with the economic feasibility analysis, and variation of at least one of capacity and usage of the selected investment resources, thereby being able to provide decision-making support for the service optimization on the basis of the prediction information (S5).

Various devices and component described herein may be achieved by a hardware circuit (e.g., a CMOS-based logic circuit), firmware, software, or a combination thereof. For example, they may be achieved by using transistors, logic gates, and electronic circuits in various electrical structures.

The above description may be changed and modified by those skilled in the art without departing from the fundamental characteristics of the present disclosure. Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the patent right of the present disclosure.

What is claimed is:

1. A service providing system for supporting service optimization operation maintenance and decision-making, the system comprising:
a terminal unit composed of a plurality of resources for providing an information technology-related service and configured to create and transmit status information for each resource, which is used every time the services are driven;
a data management unit configured to receive the status information from the terminal unit and process the status information into analysis data;
a first integration calculation unit configured to calculate capacity and usage of each of investment resources required for driving the service on the basis of the analysis data received from the data management unit, and configured to create and store operation information including the capacity and usage of each of investment resources;
an intellectual unit configured to create an optimization algorithm by teaching the interrelation between the capacity and usage of each investment resource to preset big data analysis or neural network model on the basis of the accumulated and stored operation information, and to create optimization information, in which at least one of capacity and usage of each investment resource, when driving a service by applying at least some of operation information for a present service operation status using the created optimization algorithm; and
a second integration calculation unit configured to perform economic feasibility through a preset economic feasibility analysis algorithm by comparing the operation information created through the first integration calculation unit with the optimization information created through the intellectual unit in accordance with contract information for a predetermined contract of each of investment resources, and to create, in accordance with variation, one or more different items of prediction information for a cost reduction specification according to a service driving environment, in which at least one of capacity and usage has been changed in the operation information for investment resources selected in accordance with the economic feasibility analysis, and variation of at least one of capacity and usage of the selected investment resources, thereby providing decision-making support for the service optimization on the basis of the prediction information.

2. The system of claim 1, wherein the plurality of resources includes at least one of a sensor, a physical security device, an application, software, hardware, a line, a building, electricity, a machine, a server, a rack, a utility including electricity, and manpower, and
the operation information includes at least one of the kinds of resources, intensity of light according to an environment, a frame speed, image precision, magnitude of noise, storage capacity, capacity for processing users, the number of users, search performance, performance between a storage device and a cooperation device, a CPU speed, a packet process speed, a communication speed, a round trip time (RTT), a disc speed, cooling performance, a power consumption amount, the number of invested people, and work time.

3. The system of claim 1, further comprising a user interface unit configured to display the prediction information through a display unit, to receive user input and inform a user of prediction information satisfying a preset condition in accordance with the user input, and to change setting of specific resources that are used for the service in accordance with user input or a preset operation condition.

4. The system of claim 3, wherein the intellectual unit receives setting change-related setting information about at least one of one or more resources, which are used for the service in accordance with user input through the user interface unit, and creates optimization information corresponding to the setting information by reflecting the setting information to the optimization algorithm; and
the second integration calculation unit creates one or more items of prediction information for supporting decision-making for service optimization for a service operation environment corresponding to the setting information by applying optimization information corresponding to the operation information and the setting information to the economic feasibility algorithm.

5. The system of claim 1, wherein the terminal unit creates and transmits information of each resource that is used every time driving a service according to a specific function for each of a plurality of different functions set in advance in relation to an information communication service.

6. The system of claim 1, further comprising a contract unit configured to create and providing contract information including a contract of purchase and use of each resource and a labor contract,
wherein the first integration calculation unit sets contract information received from the contract unit into the second integration calculation unit.

7. The system of claim 1, wherein when the terminal unit includes a plurality of terminals units and the plurality of terminal units are connected to each other, the data management unit has connection information set in advance about a data cooperation relationship between the plurality of terminal units and processes status information provided from each of the plurality of terminal units in accordance with the connection information into the analysis data in accordance with the data cooperation relationship.

8. The system of claim 1, wherein the second integration calculation unit applies at least one of costs of resources, a rental, a rental feel, a labor cost, a depreciation expense, an electricity charge, and a fee according to the contract information to the economic feasibility analysis algorithm to create the prediction information.

9. The system of claim 1, wherein For example, the second integration calculation unit calculates one or more service driving environments, in which the operation information has been changed, such that the difference from at least one of the usage and capacity of each investment resource, which is generated between the operation information and the optimization information, through the economic feasibility analysis algorithm, as candidate service driving environments; calculates the final profit-loss by calculating and adding up profit-loss in accordance with each of investment resources, which need at least one of enlargement, a personnel increase, reduction, personnel reduction, performance optimization, service structure improvement, infrastructure optimization, utilization optimization, distribution, and bottleneck improvement according to the difference between the present service driving environment and the candidate service driving environments for each of the one or more candidate service driving environments; and creates the prediction information for each candidate service driving environment in which the final profit-loss satisfies a predetermined profit-loss condition.

10. A service providing method for supporting service optimization operation maintenance and decision-making, the method comprising:
creating and transmitting status information for each resource, which is used every time the services are driven by means of a terminal unit composed of a plurality of resources for providing an information technology-related service;
receiving the status information from the terminal unit and processing the status information into analysis data by means of a data management unit;
calculating capacity and usage of each of investment resources required for driving the service on the basis of the analysis data received from the data management unit, and creating and storing operation information including the capacity and usage of each of investment resources by means of a first integration calculation unit;
creating an optimization algorithm by teaching the interrelation between the capacity and usage of each investment resource to preset big data analysis or neural network model on the basis of the accumulated and stored operation information, and creating optimization information, in which at least one of capacity and usage of each investment resource, when driving a service by applying at least some of operation information for a present service operation status using the created optimization algorithm by means of an intellectual unit; and
performing economic feasibility through a preset economic feasibility analysis algorithm by comparing the operation information created through the first integration calculation unit with the optimization information created through the intellectual unit in accordance with contract information for a predetermined contract of each of investment resources, and creating, in accordance with variation, one or more different items of prediction information for a cost reduction specification according to a service driving environment, in which at least one of capacity and usage has been changed in the operation information for investment resources selected in accordance with the economic feasibility analysis, and variation of at least one of capacity and usage of the selected investment resources, by means of a second integration calculation unit, thereby providing decision-making support for the service optimization on the basis of the prediction information.
